(19) United States
(12) Patent Application Publication
(10) Pub. No.: US 2006/0211446 A1
(43) Pub. Date: Sep. 21, 2006

(54) Enabling telematics and mobility services within a vehicle for disparate communication networks

(76) Inventors: Armin Wittmann, Fuerth (DE); Kai Schmitt, Nuremberg (DE)

Correspondence Address: WILLIAMS, MORGAN & AMERSON, 10333 RICHMOND, SUITE 1100, HOUSTON, TX, 77042, US

(21) Appl. No.: 11/085,904

(22) Filed: Mar. 21, 2005

(51) Int. Cl. H04Q 7/20

(52) U.S. Cl. 455/552.1; 455/413

(57) ABSTRACT

The present invention provides a method and an apparatus of communication with a first and a second mobile communication network such that the first mobile communication network is different than the second mobile communication network. The method comprises disposing a telematics unit and a gateway unit having a network interface in a vehicle to enable a wireless service and providing wireless coverage within the vehicle for the wireless service on the first or second mobile communication network. Establishment of a personal area network for a wireless coverage within a vehicle and use of a universal gateway access point for accessing disparate mobile communication networks may enable, for example, provision of one or more telematics and mobility services into a vehicle. A remote server of a vehicle service provider may wirelessly communicate with a vehicle over an available mobile communication network regardless of a network type. In this way, the remote server may provide or obtain information for remotely controlling metrics or conditions of the vehicle by analyzing the data collected at the vehicle for a particular telematics or mobility service.

### FIELD OF THE INVENTION

This invention relates generally to telecommunications, and more particularly, to wireless communications.

### DESCRIPTION OF THE RELATED ART

With integration of emerging auto technologies, recent generations of automobiles now offer more advanced on-board safety, driving, comfort, and/or operational automotive features within a vehicle. A complex set of vehicle-based auto-applications enable provision of such automotive features. More specifically, to manage information associated with a variety of vehicle-based auto-applications, many recent generations of automobiles employ several on-board microcomputers and electronics hardware.

Using various on-board microcomputers and electronics hardware, a vehicle generally collects data for a host of auto-applications including vehicle-based electronic applications, vehicle safety applications, mobile telephony applications, vehicle tracking and positioning applications, navigation and information services and/or emergency assistance applications. Other auto-applications may include automatic sensing and/or monitoring of different metrics of the vehicle.

For implementing the auto-applications set forth above, most of the on-board microcomputers and electronics hardware use firmware or software, such as embedded software to operate, monitor, and control various functions of the vehicle. A rapid increase in the complexity of the embedded software, however, necessitates frequent vehicle maintenance involving software upgrades.

One way to upgrade such software involves performing an upgrade at a dealer location or an auto workshop. But recalling the vehicle back to the dealer location or the auto workshop each time a software upgrade is desired adds to the overall cost of an auto dealer and/or manufacturer. Moreover, such an approach expects a customer to repeatedly visit the dealer location or the auto workshop, a practice that may not be acceptable to most customers.

In contrast, a self-upgrade of the embedded software by the customer, e.g., from the Internet, may be possible albeit risky since an improper procedure may result in damage to the vehicle and/or jeopardize the safety of the customer. Some remote software maintenance systems enable upgrading of the software via an Internet access within the customer's garage. However, customers may not have an Internet access available at home, especially in their garage.

To this end, many telematics technologies are used in automotive communications to handle voice and data. Telematics generally refers to services and infrastructure that use a telecommunications link to provide for rapid and dynamic collection and dissemination of data and/or media content including voice, image and video over a computer network. For example, a telematics or a telecontrol system within a car includes a central control unit to deal with an alarm and controlling its operation within the car. For maintenance or repair of such a telematics or a telecontrol system, the collected data has to be analyzed. To read out any collected data from the car, however, a user, owner, customer, or a driver has to drive the car to a car dealer or an auto repair shop that has a car telematics or telecontrol diagnostics system. Besides, an apparent inconvenience of taking the car to the car dealer or the auto repair shop there are costs also associated with the maintenance or repair visit.

Mobile data solutions enable business users to access their corporate networks while out of the office. For example, 3^{rd} Generation (3G) mobile data and Wi-Fi wireless local area networks (LANs) provide a mobile data solution for users of laptop and personal digital assistant (PDA) devices based on a Global System for Mobile Communication (GSM) or a Code Division Multiple Access (CDMA2000) protocol or a Universal Mobile Telecommunication System (UMTS) protocol. Service providers deliver a solution that provides such corporate users information practically anywhere at anytime.

One type of a wireless service is provided within a car over a 3G network using a mobile terminal. However, the mobile terminal has to provide network interfaces to all possible 3G standards to be fully flexible and to ensure best quality of service (QoS). The Quality of service within the car is sometimes unacceptable to a user due to an inadequate wireless coverage within the car.

In addition, a significantly high output power of the mobile terminal may pose a health hazard to the user. Having all the possible 3G interfaces to maintain flexibility, one may be forced to continually buy the latest available mobile terminal equipment. However, over time, the mobile terminal may become incompatible with the car or due to sheer distances or signal strength (i.e., shielding effect of the car may result in Faraday's cage) the mobile terminal may be unable to access a base station.

The present invention is directed to overcoming, or at least reducing, the effects of, one or more of the problems set forth above.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method of communication is provided with a first and a second mobile communication network wherein the first mobile communication network is different than the second mobile communication network. The method comprises disposing a telematics unit and a gateway unit having a network interface in a vehicle to enable a wireless service and providing wireless coverage within the vehicle for the wireless service on the first or second mobile communication network.

In another embodiment, a communication system provides a service for a vehicle over a first and a second mobile communication network wherein the first mobile communication network is different than the second mobile communication network. The communication system comprises a gateway unit having a network interface disposed in the vehicle to enable a wireless service and a telematics unit coupled to the gateway unit to provide wireless coverage within the vehicle for the wireless service on the first or second mobile communication network using the network interface.

In yet another embodiment, a vehicle associated with a vehicle service provider in a communication system provides a service for the vehicle over a first and a second mobile communication network such that the first mobile communication network is different than the second mobile communication network. The vehicle comprises a plug-in data card that includes a gateway unit having a network interface to enable a wireless service and a telematics unit coupled to the plug-in data card to provide wireless coverage within the vehicle for the wireless service on the first or second mobile communication network using the network interface.

In still another embodiment, a vehicle service provider associated with a vehicle in a communication system provides a service for the vehicle over a first and a second mobile communication network wherein the first mobile communication network is different than the second mobile communication network. The vehicle service provider comprises a controller and a storage coupled to the controller. The storage stores instructions to communicate with the vehicle through a gateway unit disposed at the vehicle and remotely control at least one function of a telematics unit disposed at the vehicle.

### BRIEF DESCRIPTION OF THE DRAWINGS

The invention may be understood by reference to the following description taken in conjunction with the accompanying drawings, in which like reference numerals identify like elements, and in which:

FIG. 1 schematically depicts a block diagram of a communication system associated with a wireless network enables a wireless coverage on a personal area network within a vehicle for at least two different types of wireless services over disparate mobile communication networks in accordance with one embodiment of the present invention;

FIG. 2 schematically illustrates the vehicle original equipment manufacturer details within the communication system of FIG. 1 for remotely providing telematics and mobility services to a user of the vehicle according to one embodiment of the present invention;

FIG. 3 schematically depicts a satellite-based communications system for implementing the communication system shown in FIG. 1 to provide a wireless coverage for at least one telematics service along with a mobility service into the vehicle;

FIG. 4 illustrates a stylized representation of a flow chart implementing a method of communication with the wireless network using a universal network interface in the gateway unit for communicating with the disparate mobile communication networks consistent with one embodiment of the present invention;

FIG. 5 illustrates a stylized representation of a flow chart implementing a method of either automatically or in response to a service request providing a telematics and/or a mobility service within the communication system of FIG. 1 in accordance with one embodiment of the present invention; and

FIG. 6 illustrates a stylized representation of a flow chart implementing a method of remotely controlling the telematics unit at the vehicle from the remote server of the vehicle service provider shown in FIG. 1 according to one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which will vary from one implementation to another. Moreover, it should be appreciated that such a development effort might be complex and time-consuming, but may nevertheless be a routine undertaking for those of ordinary skill in the art having the benefit of this disclosure.

Generally, a method of communication and a communication system associated with a wireless network enables a wireless coverage on a personal area network within a vehicle for at least two different types of wireless services over disparate mobile communication networks. In accordance with one embodiment of the present invention, a vehicle may include a gateway unit having a network interface coupled to a telematics unit for communicating with a remote server of a vehicle service provider to provide the wireless services including one or more telematics and mobility services either to a user of the vehicle and/or to a vehicle manufacturer or dealer or a wireless service provider. The gateway unit and the network interface may provide a universal gateway access point for enabling, for example, Third Generation (3G) Standard mobility services that may be provided into the vehicle, such as within a car by allowing a universal control of the telematics unit. A common access to other wireless applications within the vehicle may also be provided. Using such an interface with one or more telematics and mobility services, a remote access to the telematics unit may be provided. A remote access may allow the vehicle to stay “online” so that it may be reached for providing information about different vehicle conditions, such as position, status and alarms. This vehicle data may allow for many vehicle-based applications, such as a billing service for toll, sending of information for a preventive maintenance to allow for repair parts to be made available at a repair shop, before a customer even arrives. Moreover, remote software updates may be provisioned.

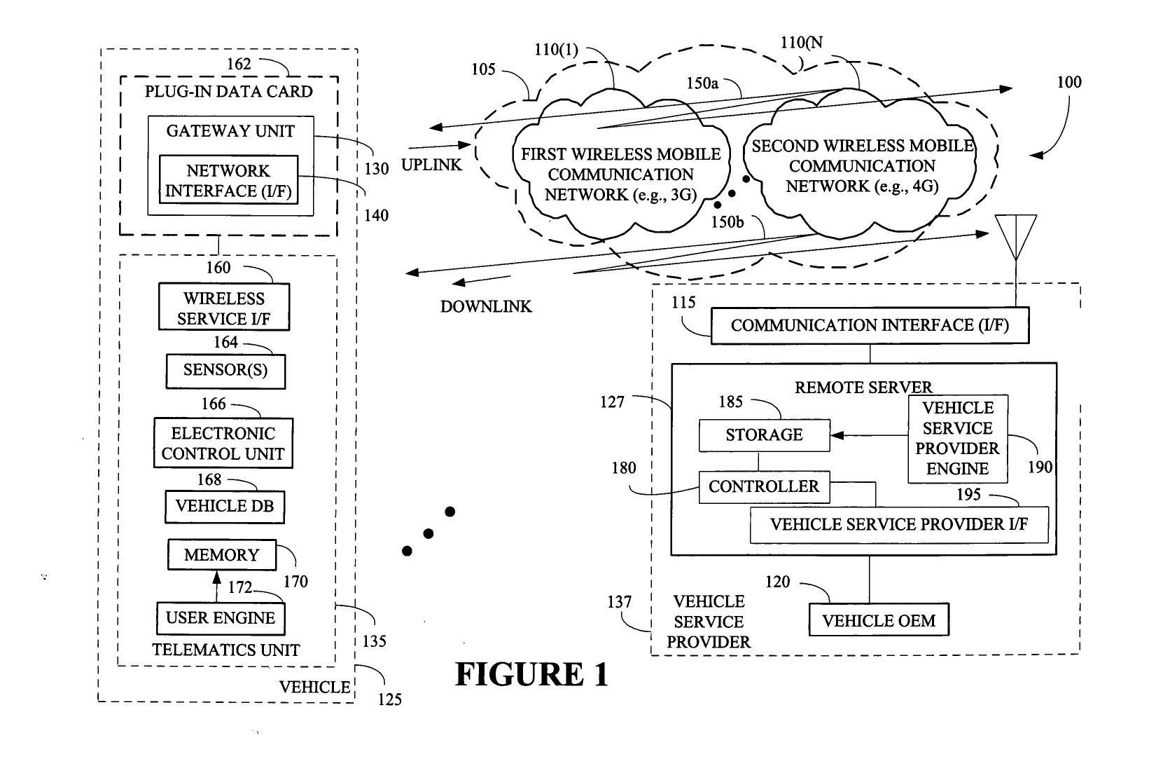

Referring to FIG. 1, a block diagram of a communication system 100 is schematically depicted in accordance with one embodiment of the present invention. The communication system 100 may associate with a wireless network 105 comprising a plurality of disparate mobile communication networks 110(1-N) including a first and a second mobile communication networks 110(1-2). An example of the first and second mobile communication network 110(1-2) includes a digital cellular network. The wireless network 105 may be coupled to a conventional communication interface (COMM I/F) 115 associated with a vehicle original equipment manufacturer (OEM) 120 for enabling a wireless service on the first and second mobile communication networks 110(1-2). Examples of the wireless service include at least two different types of services available to a user of a vehicle 125 and/or to the vehicle OEM 120.

The first mobile communication network 110(1) may be different than the second mobile communication network 110(2) in at least one aspect. More specifically, according to one exemplary embodiment of the present invention, the first and second mobile communication networks 110(1-2) may be based on, for example, any one of the 2G/3G/4G standards. In addition or alternatively, the first and second mobile communication networks 110(1-2) may operate on two different protocols. Therefore, the plurality of disparate mobile communication networks 110(1-N) may use any one of the 2G, 3G, or 4G standards and employ any one of the protocols including the UMTS, CDMA200, GSM, or the like. However, use of a particular standard or a specific protocol by the first and second mobile communication networks 110(1-2) is a matter of design choice and not necessarily material to the present invention.

The communication system 100 may provide a wireless coverage within the vehicle 125 for the user to avail one or more telematics services and one or more mobility services accessible at least on the first and second mobile communication networks 110(1-2). The vehicle OEM 120 may offer and/or obtain data associated with such telematics and mobility services over the plurality of disparate mobile communication networks 110(1-N). To communicate within the communication system 100, a wireless communication medium, such as an air interface that is capable of transmitting and receiving mobile communications over desired radio frequencies (RFs) may be deployed.

While a telematics service may involve vehicle specific features, a mobility service may involve non-vehicle specific features. Examples of the vehicle specific features include but not limited to, navigation and traffic information, airbag notification, emergency call, roadside assistance, vehicle tracking, remote diagnostics, warranty information, maintenance information, software update, adaptive cruise control and Global Positioning System (GPS)—a satellite-based navigation system based intelligent transportation. Likewise, examples of the non-vehicle specific features include but not limited to, news, points of interest information, banking, shopping, concierge services, music downloads, video or movie downloads, interactive games, e-mail, Internet/Intranet access, phone services.

For the purposes of enabling such different telematics and mobility services to the user and/or the vehicle OEM 120, the vehicle 125 may be coupled to the (COMM I/F) 115 through a remote server 127. Using the (COMM I/F) 115, the remote server 127 may wirelessly communicate with the vehicle 125 over the wireless network 105. For maintenance or repair of the vehicle 125, the remote server 127 may analyze the data collected at the vehicle 125 for a particular telematics service. Of course, the telematics and mobility services may also be offered by other providers than automobile manufactures, i.e., the vehicle OEM 120. For instance, content providers including media companies, software manufacturers, telecommunications companies, satellite telecommunications companies, public or private transport companies, and financial institutions.

In one embodiment, the vehicle 125 may include a gateway unit 130 coupled to a telematics or a telecontrol unit 135 to provide wireless coverage for the different telematics and mobility services. The gateway unit 130 may exchange information across the disparate mobile communication networks 110(1-N) by translating between two dissimilar protocols being used by the two incompatible networks or systems. The telematics unit 135 may use mobile communications between the gateway unit 130 and the (COMM I/F) 115 over the wireless network 105 to manage information for and/or disseminate data associated with a variety of vehicle-based auto-applications, such as vehicle safety auto-applications at the vehicle 125 to the vehicle OEM 120.

The communication system 100 may further comprise a vehicle service provider 137. The vehicle service provider 137 may provide services based on external databases capable of interacting with the telematics unit 135. To this end, the vehicle service provider 137 may use different features available on an Information Management System (IMS)—an Internet web-based communications and information exchange tool and the telematics unit 135 to enable a converged network for a user to obtain a desired support, e.g., depending on a particular situation or based on availability of certain data. For example, if the vehicle 125 is about to run out of petrol, the communication system 100 may indicate a next “bonus” program petrol station. Likewise, if a vehicle part or component develops a defect, the communication system 100 may indicate a next repair station, and a location where this part or component may be available for purchase or replacement. Therefore, in one embodiment, the vehicle service provider 137 may not necessarily be a service provider of a 3G network access.

More specifically, in accordance with an exemplary embodiment of the present invention, the gateway unit 130 may comprise a network interface (I/F) 140. The network I/F 140 may include a hardware device that uses a firmware or software program to translate information between incompatible protocols. The network I/F 140 may use a network layer address, such as a node address of a specific user to send out information on an uplink 150a and to receive information on a downlink 150b over the wireless network 105.

For example, the remote server 127 may use the uplink 150a for condition monitoring at the vehicle 125. Likewise, the downlink 150b may be user to provide a software update for the telematics unit 135. Accordingly, via the network I/F 140 and without an intervention from a user, owner, customer, or a driver of the vehicle 125, the remote server 127, i.e., the vehicle OEM 120 may provide support or an upgrade for a telematics service or a mobility service over the wireless network 105.

Consistent with one embodiment, to a user of a wireless service, such as a mobility service or a telematics service of the vehicle 125, the network I/F 140 of the gateway unit 130 provides a common access point capable of adapting to various network standards accessible over the wireless network 105, such the disparate mobile communication networks 110(1-N) based on the 2G/3G/4G standards, for example. The network I/F 140 may function at any one layer of a communication network protocol layer model or at several layers simultaneously in the wireless network 105. The gateway unit 130 may translate information from one format to another format for the network I/F 140 to adapt the disparate mobile communication networks 110(1-N). As a result, incompatible mobile communication networks, operating on different protocols may become accessible from the vehicle 125.

In this manner, the network I/F 140 may be used with the disparate mobile communication networks 110(1-N), examples of which include, the 3^{rd} Generation (3G) mobile data and Wi-Fi wireless local area networks (LANs). The network I/F 140 may provide different telematics and mobility services to the user of a mobile terminal, such as a laptop or a personal digital assistant (PDA) device based on a GSM protocol or a CDMA2000 protocol or a UMTS protocol. To this end, the network I/F 140 may provide one or more interfaces for the telematics unit 135 to access or communicate with an external network. Specifically, the network I/F 140 may enable a first link via either 3G or 2G access network along with simultaneous one or more second links for a fallback or to provide at least one alternative routing path. In other words, the telematics unit 135 may operate with a desired access network and/or a multiplicity of access networks to allow a full converged solution, in some embodiments of the instant invention.

The telematics unit 135 of the communication system 100 may comprise a service interface (I/F) 160 for availing mobility and telematics services. The service I/F 160 may provide a man-machine interface for a personal area network (PAN). Examples of the PAN include a wireless local area network (WLAN) and a short-range wireless network such as based on the Bluetooth standard. The telematics unit 135 may further comprise a plug-in data card 162 that provides means for communications out of the vehicle 125. The service I/F 160 may enable one or more vehicle-based mobility services and telematics services that include vehicle tracking and positioning services, navigation services, emergency assistance services and/or mobility services including mobile telephony, Internet access and the like. In one embodiment, the plug-in data card 162 includes the gateway unit 130.

Furthermore, the telematics unit 135 may comprise one or more sensors 164 for collecting data, an electronic control unit 166 for data processing and monitoring, a vehicle database (DB) 168 for storing the collected data, a memory 170 to store a user engine 172 that may be executed by the electronic control unit 166. The sensors 164 may collect data for storage into the vehicle DB168 from a host of such vehicle-based auto-applications including vehicle-based electronic auto-applications, mobile telephony auto-applications, vehicle tracking and positioning auto-applications, navigation and information auto-applications and emergency assistance auto-applications. The sensors 164 may provide automatic monitoring of different metrics of the vehicle 125 in some vehicle-based auto-applications. As few examples, the metrics may include engine conditions, transmission, suspension, breaking, and fuel efficiency related parameters.

By using the plug-in data card 162, the electronic control unit 166 may enable one or more vehicle-based telematics services and mobility services, such as mobile telephony. In the telematics unit 135, the user engine 172 which may comprise instructions to control mobile communications associated with a variety of vehicle-based auto-applications, such as vehicle safety auto-applications. Essentially, the user engine 172 causes the electronic control unit 166 to interact with the plug-in data card 162 for using the gateway unit 130 to enable a remote control of the telematics unit 135 by the remote server 127.

The telematics unit 135 being disposed at the vehicle 135 may cooperatively interact with the remote server 127, significantly speeding up the dissemination and analysis of the collected data at the vehicle DB 168, saving time, increasing collaboration between a customer and the vehicle OEM 120 or a group of manufacturers and suppliers. This relatively fast dissemination and analysis of the collected data and collaboration may substantially improve decision making regarding the vehicle 125.

To this end, in one embodiment, the remote server 127 may comprise a controller 180 using which a network operator for the vehicle service provider 137, i.e., the vehicle OEM 120 may obtain access to the vehicle 125 via the wireless network 105. The remote server 127 may further comprise a storage 185 that stores a vehicle service provider engine 190. Besides the vehicle service provider engine 190, a vehicle service provider interface (I/F) 195 may be provided for the controller 180 to run diagnostics on the collected data at the vehicle DB 168.

Using the vehicle service provider engine 190 and the vehicle service provider I/F 195, in one embodiment, the controller 180 of the remote server 127 may automatically read out a desired data set from the data collected at the vehicle 125. This read out of the desired data set may not involve an intervention form a user, owner, customer, or a driver. Alternatively, the vehicle 125 may automatically and/or periodically transmit the collected data to the remote server 127 for an analysis by the vehicle OEM 120.

Cooperatively, the remote server 127 and the vehicle 125 may deliver both to a user of the vehicle 125 and to the vehicle OEM 120, a mobile data solution that provides information associated with the different telematics and mobility services. Essentially, according to one embodiment of the instant invention, the communication system 100 may enable use of these different telematics and mobility services anywhere at anytime depending upon a wireless coverage available from the wireless network 105.

Therefore, according to one embodiment, the communication system 100 may provide one or more of these different telematics and mobility services regardless of a specific standard of an available mobile communication network among the first and second mobile communication networks 110(1-2). In this way, a wireless coverage may become available into the vehicle 125 for a desired disparate mobile communication network 110 of the plurality of disparate mobile communication networks 110(1-N) that may be based on a particular standard, such as the 2G, 3G, or 4G standards using any one of the protocols including the UMTS, CDMA200, GSM, or the like. However, use of a particular standard or a specific protocol in the communication system 100 to communicate on a desired wireless communication medium is a matter of design choice and not necessarily material to the present invention.

As an example, the first mobile communication network 110(1) of the plurality of disparate mobile communication networks 110(1-N) may be based on the 3G standard using the UMTS protocol to provide a high speed downlink packet access (HSDPA) to the vehicle 125. Instead, the second mobile communication network 110(2) may be based on the 4G standard using the CDMA protocol. The UMTS protocol with the HSDPA may provide a wireless coverage (e.g., emergency situations, international roaming) with a desired security when transmitting personal and automotive data at high data rates, resulting in significantly fast software download or online monitoring in the uplink 150a.

More specifically, the HSDPA may employ the UMTS protocol of Release 5 with a UMTS channel bandwidth of 5 MHz for high peak data rates up to 14 Mbps. The HSDPA may use an adaptive modulation and coding schemes for automatic re-transmission mechanism, such as hybrid automatic repeat request (HARQ). In case of a multiple-input multiple-output (MIMO) system a peak date rate up to 21.6 Mbps may be provided by employing the UMTS protocol of Release 6.

To provide one or more telematics services or other mobility or wireless services, the telematics unit 135 may use a phone or a radio to link the vehicle 125 to the controller 180, and in turn, to the vehicle OEM 120, for sending and receiving mobile communications via a cellular connection based on a radio frequency (RF) communication link. The controller 180 at the remote server 127 may communicate with the vehicle OEM 120 on the Internet using a conventional Transmission Control Protocol/Internet Protocol (TCP/IP) protocol.

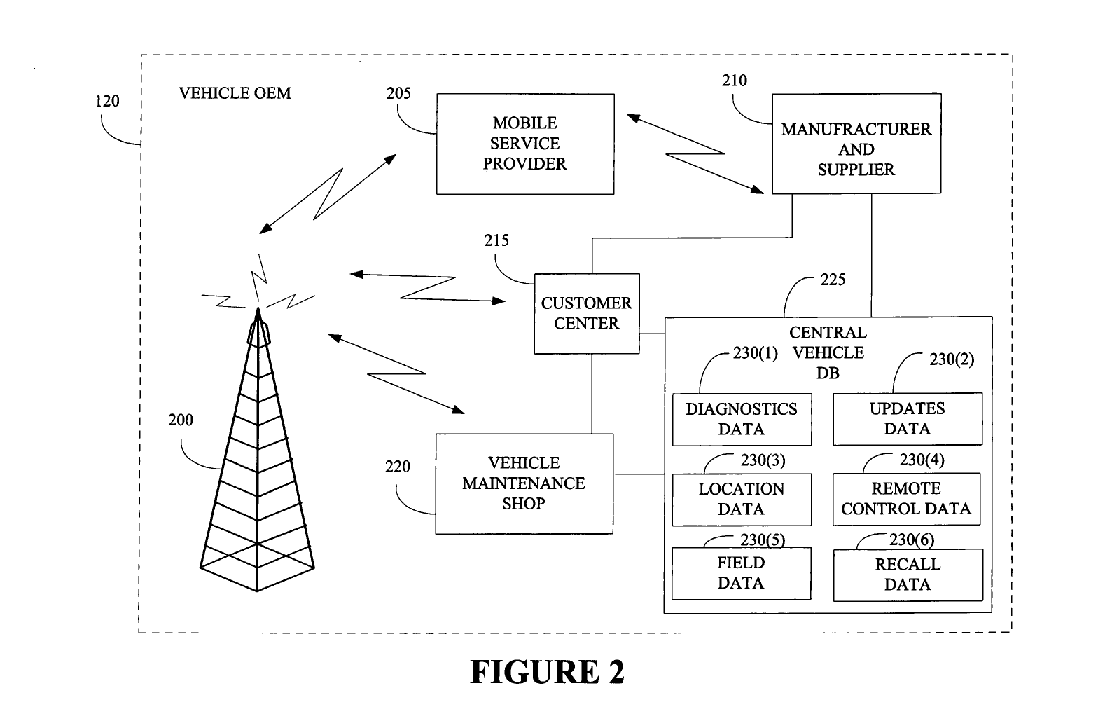

Turning now to FIG. 2, for remotely enabling provision of one or more telematics and mobility services to a user of the vehicle 125, some of details of the vehicle OEM 120 shown in the communication system 100 of FIG. 1 are schematically illustrated according to one embodiment of the present invention. That is, only relevant aspects of the vehicle OEM 120 in the communication system 100 that are material to the instant invention are described below. As shown in FIG. 2, the vehicle OEM 120 may comprise a network 200 that may wirelessly communicate with a mobile service provider 205, a manufacturer and supplier 210, a customer center 215 and a vehicle maintenance shop 220.

The network 200 may enable the vehicle OEM 120 to access and/or monitor and/or send or receive data associated with the vehicle 125 for the wireless services offered or subscribed to either by the user or a wireless service provider, a vehicle dealer, or an automobile producer. To this end, the vehicle OEM 120 may solicit cooperation and communication with the mobile service provider 205, the customer center 215, and the vehicle maintenance shop 220.

Within a central vehicle database (DB) 225, over a telephone line or other form of wired and/or wireless link, the remote server 127 may collect data from the vehicle 125 of many types or forms associated with different telematics and mobility services. For the vehicle OEM 120, the vehicle 125 may provide such data associated with various telematics and mobility services. In one embodiment, the central vehicle DB 225 may store diagnostics data 230(1), updates data 230(2), location data 230(3), remote control data 230(4), field data 230(5), and recall data 230(6).

In particular, consistent with one embodiment, the diagnostics data 230(1) may be based on any diagnostics being run remotely by the remote server 127 for the vehicle service provider 137 at the vehicle 125. Likewise, as described above, the updates data 230(2) may correspond to any updates of software or firmware that may be desired or already performed. Similarly the location data 230(3) may be related to any navigation services being offered to the user of the vehicle of the vehicle OEM by the vehicle service provider 137.

The remote control data 230(4) may indicate data collected during controlling at least one function of the telematics unit 135 from the remote server 127. For example, a scheduled maintenance task may be performed at the vehicle by the vehicle service provider 137 without having to have the vehicle visit the vehicle maintenance shop 220, and if desired, a repair mar may be carried out at visit the vehicle maintenance shop 220. While the field data 230(5) may be concerned with data obtained at the vehicle by the sensors 164, the recall data 230(6) may refer to a recall history and/or a pending recall of the vehicle 125.

For the remote server 127, a telematics service may collect and analyze different types of data for a user, such as a driver of the vehicle 125 with safety information including automatic airbag deployment notification, vehicle tracking and personalized information, real-time traffic information, emergency aid information, and entertainment. Some features include Internet access, voice activation, and the ability to control the car audio and climate control. The telematics service may cater to the manufacturer and supplier 210 of the vehicle 125 by collecting, providing, monitoring or obtaining data for dissemination at the central vehicle DB 225.

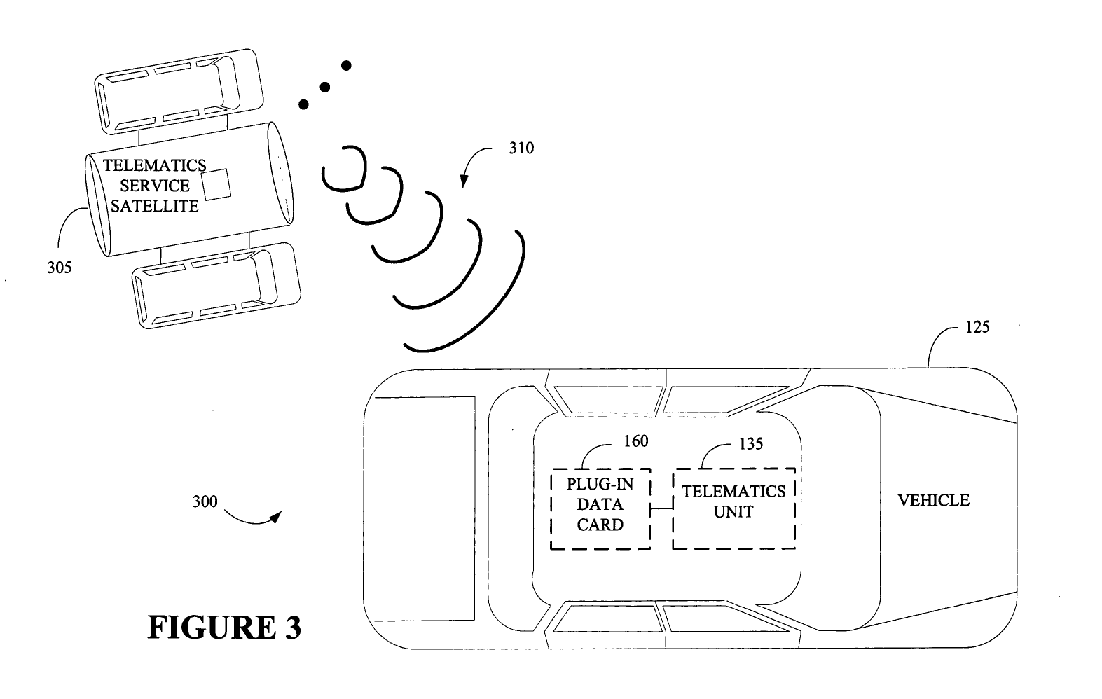

Referring to FIG. 3, a satellite-based communications system 300 is schematically depicted for implementing the communication system 100 shown in FIG. 1 to provide a wireless coverage for at least one telematics service along with a mobility service at the vehicle 125. The satellite-based communications system 300 uses Global Positioning System (GPS) which involves a satellite-based navigation using satellites, receivers and software to allow the vehicle 125 to determine its exact geographic position.

Using the plug-in data card 160 with the telematics unit 135, the user of the vehicle 125 may subscribe to a telematics service for personal tracking, navigation and automatic vehicle location determination using the satellite-based communications system 300. Likewise, an automobile manufacturer, i.e., the vehicle OEM 120 either may directly sign-up for another telematics service with the satellite-based communications system 300 or use the remote server 127 that employs services of the satellite-based communications system 300.

To implement the communication system 100, the satellite-based communications system 300 may use a series of geosynchronous satellites 305 that continuously transmit their position so that the user of the vehicle 125 being a subscriber of a telematics service may receive personal tracking, navigation and automatic vehicle location determination. As shown in FIG. 1, the telematics unit 135 at the vehicle 125 may calculate its absolute geographic position by computing the time difference for signals 310, from different satellites 305 that reach the gateway unit 130 to determine its relative position to a set of at least three satellites. In this way, the telematics unit 135 may obtain the exact latitude and longitude position of the vehicle 125.

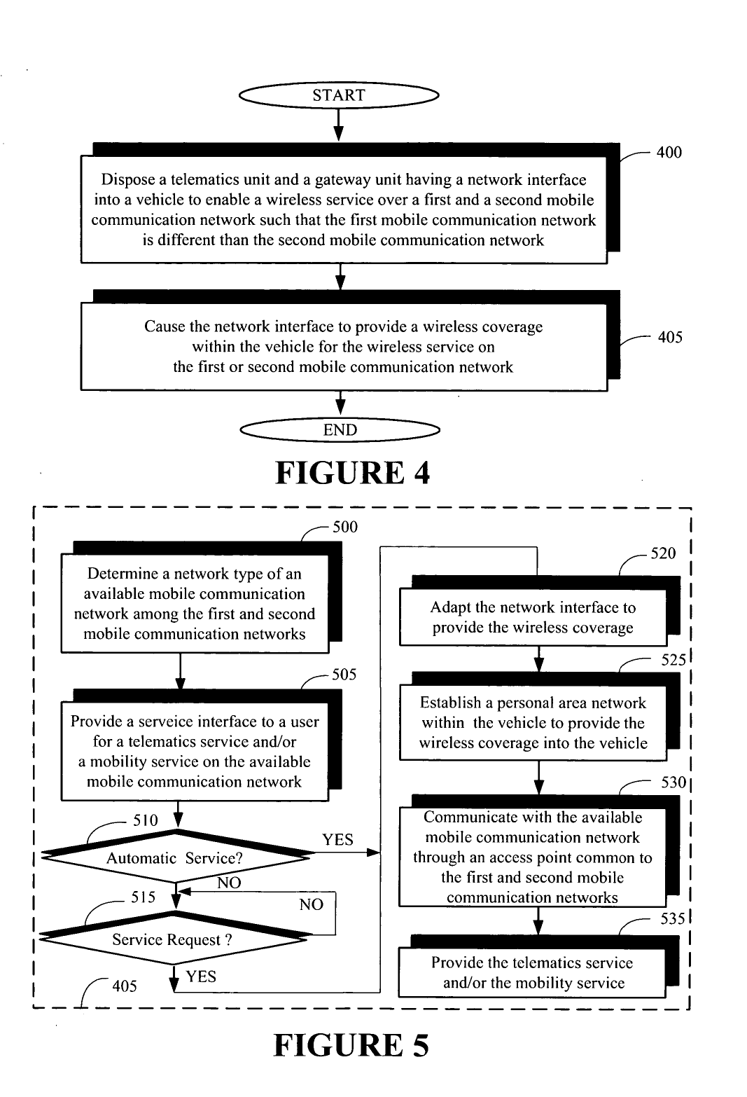

As shown in FIG. 4, a stylized representation of a flow chart implementing a method is illustrated for communication with the wireless network 105 using the network (I/F) 140 in the gateway unit 130 that provides a universal interface for communicating with the disparate mobile communication networks 110(1-N) consistent with one embodiment of the present invention. That is, the network I/F 140 may be adapted to operate as the universal interface for at least two of the disparate mobile communication networks 110(1-N). This universal nature of the network I/F 140 may enable provision of a desired telematics or mobility service over the wireless network 105 via the Bluetooth network at the vehicle 125 regardless of a certain type of mobile communication network 110 that is accessible to the gateway unit 130.

Within the vehicle 125, the universal interface of the gateway unit 130, i.e., the network I/F 140 may provide a common access point for the telematics unit 135 by converting different types of mobile communications from the disparate mobile communication networks 110(1-N). To realize such a universal interface, however, the gateway unit 130 may terminate an inbound mobile communication at the network I/F 140 with the intent of presenting it as a new outbound mobile communication through the network I/F 140. Essentially, the gateway unit 130 treats a mobile communication as if it were the final receiver for that mobile communication.

As shown in FIG. 4, at block 400, the telematics unit 135 and the gateway unit 135 having the network I/F 140 may be disposed into the vehicle 125 to enable a wireless service, such as a telematics or a mobility service. In the communication system 100, for example, the wireless service may be provided over the first or the second mobile communication networks 110(1-2) wherein the first mobile communication network 110(1) is different than the second mobile communication network 110(1). This difference in the first and second mobile communication networks 110(1-2) may be based on the standard used and/or the protocol deployed for carrying out the communications between the vehicle 125 and the vehicle service provider 137, as shown in FIG. 1.

At block 405, based on an interaction between the vehicle 125 and the vehicle service provider 137, the communication system 100 may cause the network I/F 140 to provide a wireless coverage within the vehicle 125 for that wireless service. This wireless coverage may be made available either on the first mobile communication network 110(1) or the second mobile communication network 110(2) depending upon an availability of a particular mobile communication network indicated to the gateway unit 130 by the wireless network 105.

Turning now to FIG. 5, a stylized representation of a flow chart implementing a method for, either automatically or in response to a service request, providing a telematics and/or a mobility service within the communication system of FIG. 1 is illustrated in accordance with one embodiment of the present invention. At block 500, the gateway unit 130 may determine a network type of an available mobile communication network among the first and second mobile communication networks 110(1-2). The wireless service I/F 160 may be provided, at block 505, to a user for at least one of a telematics service and a mobility service on the available mobile communication network.

A check at a decision block 510 may ascertain whether or not an automatic service is to be provided. If the check at the decision block 510 indicates that the telematics service or the mobility service is not to be automatically provided, another check at a decision block 515 may determine if a service request is initiated. However, when an automatic service is desired based on a predefined criterion or the service request is present, at block 520, the network I/F 140 may be adapted to provide the wireless coverage.

At block 525, a personal area network may be established within the vehicle 125 to provide the wireless coverage. For example, a short-range wireless network, such as a network based on the Bluetooth standard or a WLAN may be established into the vehicle 125. Using the personal area network, the gateway unit 135 may communicate with the available mobile communication network through an access point common to the first and the second mobile communication networks 110(1-2), i.e., the network I/F 140, as indicated in block 530. At block 535, in this manner, the telematics or the mobility service may be provided.

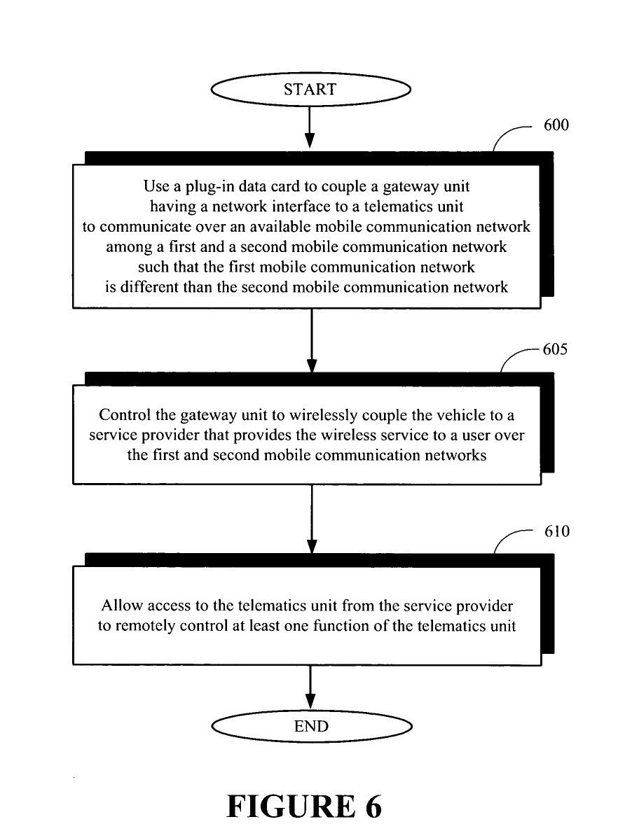

Finally, FIG. 6 illustrates a stylized representation of a flow chart implementing a method of remotely controlling the telematics unit 135 at the vehicle 125 from the remote server 127 of the vehicle service provider 137 shown in FIG. 1 according to one embodiment of the instant invention. At block 600, the plug-in data card 160 may be used to couple the gateway unit 130 to the telematics unit 135 to communicate over an available mobile communication network among the first and second mobile communication networks 110(1-2). The vehicle OEM 120 may control the gateway unit 130 to wirelessly couple the vehicle 125 to the vehicle service provider 137 that provides the wireless service to a user over either the first or second mobile communication networks 110(1-2) and the established personal area network, as set forth in block 605.

At block 610, the remote server 127 may allow access to the telematics unit 135 from the vehicle service provider 137 to the vehicle OEM 120, for example, to remotely control at least one function of the telematics unit 135. Examples of one or more functions of the telematics unit 135 include functions that control the sensors 164 for automatic monitoring of different metrics of the vehicle 125. In one embodiment, these functions may cause the telematics unit 135 to remotely control, monitor, and/or update several metrics including embedded software engine, transmission, suspension, breaking, and fuel efficiency related parameters at the vehicle 125. By monitoring and collecting the vehicle data for the vehicle metrics from the vehicle 125 and feedbacking the collected data to the vehicle OEM 120, for example, may enable an optimization of future vehicle manufacture, research and development.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention set forth above is described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

While the invention has been illustrated herein as being useful in a telecommunications network environment, it also has application in other connected environments. For example, two or more of the devices described above may be coupled together via device-to-device connections, such as by hard cabling, radio frequency signals (e.g., 802.11(a), 802.11(b), 802.11(g), Bluetooth, or the like), infrared coupling, telephone lines and modems, or the like. The present invention may have application in any environment where two or more users are interconnected and capable of communicating with one another.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices as well as executable instructions contained within one or more storage devices. The storage devices may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions, when executed by a respective control unit, causes the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

We claim:

1. A method of communication with a first and a second mobile communication network wherein the first mobile communication network is different than the second mobile communication network, the method comprising:
disposing a telematics unit and a gateway unit having a network interface in a vehicle to enable a wireless service; and
providing wireless coverage within said vehicle for said wireless service on said first or second mobile communication network.

2. A method, as set forth in claim 1, wherein disposing a telematics unit and a gateway unit further comprising:
coupling said gateway unit to said telematics unit to communicate over an available mobile communication network among the first and second mobile communication networks.

3. A method, as set forth in claim 1, wherein providing wireless coverage within said vehicle for said wireless service further comprising:
causing said network interface to provide said wireless coverage within said vehicle for said wireless service; and
providing a service interface to a user to avail at least one of a telematics service and a mobility service.

4. A method, as set forth in claim 1, further comprising:
determining a network type of an available mobile communication network among the first and second mobile communication networks; and
providing a service interface to a user for at least one of a telematics service and a mobility service on said available mobile communication network.

5. A method, as set forth in claim 4, further comprising:
in response to a service request, adapting said network interface to provide said wireless coverage at said vehicle for at least one of said telematics service and said mobility service.

6. A method, as set forth in claim 5, further comprising:
in response to said service request, communicating with said available mobile communication network through an access point common to the first and second mobile communication networks.

7. A method, as set forth in claim 1, wherein providing wireless coverage further comprising:
adapting said network interface to cause said gateway unit to enable said wireless coverage of said wireless service within said vehicle on an air interface common to the first and second mobile communication networks.

8. A method, as set forth in claim 7, wherein adapting said network interface further comprising:
establishing a short-range wireless network within said vehicle.

9. A method, as set forth in claim 7, wherein adapting said network interface further comprising:
establishing a wireless local area network within said vehicle.

10. A method, as set forth in claim 1, further comprising:
controlling said gateway unit to wirelessly couple said vehicle to a vehicle service provider that provides said wireless service to a user over the first and second mobile communication networks; and
allowing access to said telematics unit from said vehicle service provider to remotely control at least one function of said telematics unit.

11. A communication system to provide a service for a vehicle over a first and a second mobile communication network wherein the first mobile communication network is different than the second mobile communication network, said communication system comprising:
a gateway unit having a network interface disposed in said vehicle to enable a wireless service; and
a telematics unit coupled to said gateway unit to provide wireless coverage within said vehicle for said wireless service on the first or second mobile communication network using said network interface.

12. A communication system, as set forth in claim 11, further comprising:
a vehicle service provider that provides said wireless service to a user over the first and second mobile communication networks, wherein the first and second mobile communication networks enable said vehicle service provider to:
communicate with said vehicle through said gateway unit; and
remotely control at least one function of said telematics unit.

13. A communication system, as set forth in claim 12, wherein said vehicle service provider further comprising:
a communication interface to communicate with said network interface of said gateway unit at said vehicle in an uplink and a downlink mobile communication over the first and second mobile communication networks.

14. A communication system, as set forth in claim 13, wherein said vehicle service provider further comprising:
a remote server coupled to said communication interface to provide to a user at least one mobility service on an available mobile communication network among the first and second mobile communication networks.

15. A communication system, as set forth in claim 13, wherein said vehicle service provider further comprising:
a remote server coupled to said communication interface to provide to a vehicle manufacturer or a vehicle dealer or a wireless service provider at least one telematics service on an available mobile communication network among the first and second mobile communication networks.

16. A vehicle associated with a vehicle service provider in a communication system to provide a service for said vehicle over a first and a second mobile communication network wherein the first mobile communication network is different than the second mobile communication network, said vehicle comprising:
a plug-in data card that includes a gateway unit having a network interface to enable a wireless service; and
a telematics unit coupled to said plug-in data card to provide wireless coverage within said vehicle for said wireless service on the first or second mobile communication network using said network interface.

17. A vehicle, as set forth in claim 16, wherein said plug-in data card and said telematics unit are being defined at least in part by Third Generation standard.

18. A vehicle, as set forth in claim 16, wherein said telematics unit further comprising:
a service interface that provides a man-machine interface for a personal area network within said vehicle to provide said wireless coverage for said wireless service including at least one of a telematics service and a mobility service.

19. A vehicle, as set forth in claim 18, wherein said telematics unit further comprising:
one or more sensors for collecting data associated with said wireless service including at least one of a telematics service and a mobility service; and
a database for storing the collected data at said vehicle for said at least one of said telematics service and said mobility service.

20. A vehicle, as set forth in claim 20, wherein said telematics unit further comprising:
an electronic control unit for processing and monitoring the collected data in said database; and
a memory storing instructions that cause said electronic control unit to interact with said plug-in data card for using said gateway unit to enable a remote control of the telematics unit by said vehicle service provider.

21. A vehicle service provider associated with a vehicle in a communication system to provide a service for said vehicle over a first and a second mobile communication network wherein the first mobile communication network is different than the second mobile communication network, said vehicle service provider comprising:
a controller; and
a storage coupled to said controller, said storage storing instructions to communicate with said vehicle through a gateway unit disposed at said vehicle and remotely control at least one function of a telematics unit disposed at said vehicle.

22. A vehicle service provider, as set forth in claim 21, wherein said vehicle service provider is being defined at least in part by Third Generation standard.

23. A vehicle service provider, as set forth in claim 21, wherein said vehicle service provider further comprising:
a communication interface to communicate with said network interface of said gateway unit at said vehicle in an uplink and a downlink mobile communication over the first and second mobile communication networks.

24. A vehicle service provider, as set forth in claim 23, wherein said vehicle service provider further comprising:
a remote server coupled to said communication interface to provide to a user at least one mobility service on an available mobile communication network among the first and second mobile communication networks.

25. A vehicle service provider, as set forth in claim 23, wherein said vehicle service provider further comprising:
a remote server coupled to said communication interface to provide to a vehicle manufacturer or a vehicle seller or a vehicle dealer at least one telematics service on an available mobile communication network among the first and second mobile communication networks.
